(19) United States
(12) Patent Application Publication
(10) Pub. No.: US 2012/0203364 A1
(43) Pub. Date: Aug. 9, 2012

(54) METHOD AND APPARATUS FOR SECURE REMOTE REAL TIME COLLABORATIVE ACOUSTIC PERFORMANCE RECORDINGS

(76) Inventor: William Gibbens Redmann, Glendale, CA (US)

(21) Appl. No.: 13/360,763

(22) Filed: Jan. 29, 2012

Related U.S. Application Data
(60) Provisional application No. 61/440,393, filed on Feb. 8, 2011.

(51) Int. Cl. G06F 17/00

(52) U.S. Cl. 700/94

(57) ABSTRACT

A system and method are disclosed for real time, distributed, live acoustic performance collaborations having improved security. The distributed collaboration includes multiple artists (performers, artists, engineers, technicians, or directors), at multiple locations. Distinct audio watermarks tag the real time, live performance sent to each remote workstation, to deter illicit duplication and distribution. Only an authorized workstation can obtain the unwatermarked master.

### CROSS REFERENCE TO RELATED APPLICATIONS

This application claims the benefit of U.S. Provisional Patent Application No. 61/440,393, filed Feb. 8, 2011, incorporated herein by reference in its entirety.

### FIELD OF THE INVENTION

The present invention relates generally to a system for forensic watermarking of acoustic performances. More particularly, the invention relates to a system for audio production in which work group participants' contributions, as distributed within the work group, receive forensic watermarks, but in the final mix may be obtained at an authorized station free of watermarking.

### BACKGROUND OF THE INVENTION

In U.S. Pat. No. 7,853,342 (hereinafter “Redmann”), incorporated herein by reference, Redmann teaches a mechanism and method to permit real time distributed acoustic performance by multiple performers at remote locations. In one embodiment, Redmann teaches a telephone-based system that has no packet-related latency at the workstation, but for collaborations using packet-based wide-area networks (e.g., the Internet), real time audio data would preferably have a frame size of 5-10 mS, though up to 30 mS may be tolerable. According to Redmann, to minimize the bandwidth and/or to improve the resiliency of the real time audio transmission, the audio data is encoded using a codec having a matching frame size and is then sent, encoded, to all remote stations. The unencoded audio data is also recorded in a local store, representing a high fidelity, loss-less record of the performance of the local performer (here and throughout, the noun “store” is used in the sense of “computer memory”). When the performance is complete and real time transmission is not of the essence, the files in the corresponding stores of each participating station can be exchanged using a reliable protocol, so that each station is left with a high quality recording of the entire collaborative performance. [See Redmann, col 14, lines 32-47]

However, for some high-value collaborations, it can be improvident for all participants to be left with a copy of all the performance tracks, whether from the encoded, real time stream or the post-performance high fidelity exchange.

In scenarios such as mixing a new Lady Gaga single or finalizing the soundtrack for a soon-to-be-released studio blockbuster, there can be substantial illicit incentive to release a pirate copy of the individual tracks and/or final composition. In general, audio workstations are fundamentally insecure: An eavesdropper may copy a real time stream or the post-performance exchange; tracks created locally or received from remote stations are stored as files, which can be copied contemporaneously, or later; even when casually deleted, the data patters remain anonymously, but recoverably, in the physical mechanisms of the store.

Thus, there is a need for a distributed, collaborative, audio production tool that is able to meet the needs of performers, directors, recording engineers, and other artists, with improved security.

### OBJECTS AND SUMMARY OF THE INVENTION

The present invention is a real time, distributed, collaboration tool for live audio production to meet the needs of performers, directors, recording engineers, and other artists at multiple locations, while offering improved security. Distinct audio watermarks are applied to the real time, live performance sent to each remote workstation. However, an authorized workstation may obtain an unwatermarked master.

The invention comprises a plurality of audio workstations, at least one comprising an audio input, a store for audio tracks, a forensic watermarking module for watermarking audio data to be sent in real time to other audio workstations, an interface to a communication channel by which the audio data is communicated to other workstations, and a controller to direct and orchestrate the operation of these components.

A performer, for example an actor, narrator, Foley artist (sound effects artist), musician, or singer, provides an audio performance that is captured through the audio input to provide audio data representative of the performance. The controller directs the audio data to be both recorded as a track in the store and provided to the watermark module so that a differently watermarked copy of the audio data is transmitted to each of one or more remote audio workstations, but still in real time.

In some embodiments, the performer is presented with a timing reference, which may be a metronome (sometimes called a “click track” or “beat track”), a countdown, or audio and/or video reference material. The controller may use a synchronization module, for example comprising one or more delays, to ensure that whatever elements form the timing reference, they remain in mutual synchronization and further allow the controller to determine the synchronization between the audio data and the timing reference.

Audio data arriving in real time from other audio workstations may be played in synchrony with a performance being recorded. The synchrony may be at least partially determined by the latency of the connection through the communication channel.

In other than real time, the present invention provides that audio data recorded in the store of one audio workstation (i.e., as an unwatermarked master track) can be copied to another audio workstation, as permitted by management policies. This copy may be encrypted such that only authorized recipients can access the audio data.

One embodiment provides a first audio workstation that includes an audio input, a watermarking module, a store, an interface to a communication channel, and a controller wherein the controller captures an audio performance through the audio input as first audio data and records the first audio data as a first audio track in the store. The controller also applies a watermark to the first audio data with said watermark module to produce a second audio track which the controller sends through the interface to a remote second audio workstation connected to said communication channel, in substantially real time. Additional remote audio workstations may be sent differently watermarked tracks.

Another embodiment provides a method for distributed collaboration, and includes providing a first audio workstation comprising an audio input, a watermarking module, a store, and having a connection to at least one second audio workstation through a communication channel, logging with the workstation an association between each of the second audio workstations and a different watermark payload; capturing first data representative of a performance through the audio input; producing a second data for each of the second audio workstations by watermarking the first data with the watermarking module and the corresponding watermark payload; sending the corresponding second data to each of the second audio workstations in substantially real time; and, recording a track comprising the first data in the store.

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a detailed block diagram of one embodiment of the present invention;

FIG. 2 is detail of another embodiment having a different arrangement of watermarking module and codec;

FIG. 3 is still another embodiment of a watermarking module integrated with a codec encoder;

FIG. 4 is a database schema suitable for tracking sessions and watermarks; and,

FIG. 5 is a flowchart of a method for conducting a recording session using the system of FIG. 1.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

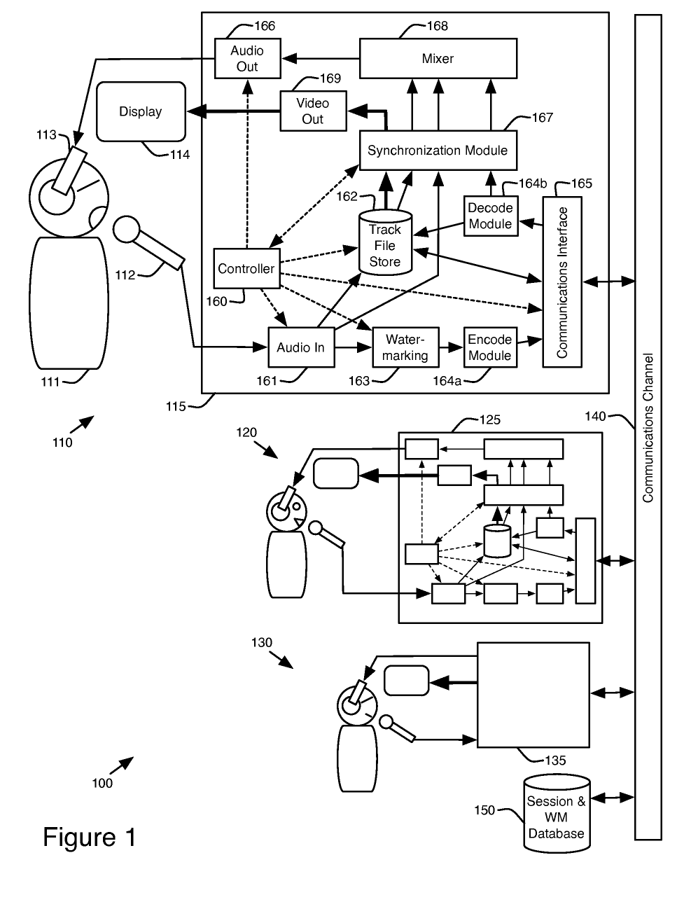

Referring to FIG. 1, secure distributed collaboration system 100 is deployed at multiple locations 110, 120, and 130, each served by communication channel 140, which may be the Internet, or other communication network, public or private. Each location is equipped with corresponding audio workstation 115, 125, and 135, and each workstation is connected to the others by way of communication channel 140. Additionally, the system includes a database 150 for storing information related to watermarks, discussed further below. In this embodiment, database 150 is implemented as a remote server, accessible to workstations 115, 125, and 135 through communications channel 140.

Communication channel 140 may comprise a private corporate network. However, it may not be uncommon for communication channel 140 to comprise the Internet, in which case security of the communication may be maintained by digital certificates at each audio workstation and the use of secure socket layer (SSL) communications, or the communication channel 140 may employ a virtual private network (VPN). Either choice would provide substantial protection against eavesdropping.

At example location 110, a performer 111 is performing (singing, in this case) into microphone 112, wearing headphones 113, and viewing display 114, when needed.

A similar configuration exists at the other locations 120, 130. The operators at those locations may be performers also, or they can be directors, recording engineers, etc., collaborating with performer 111 for the current session.

One embodiment suitable for an audio workstation of the present invention is shown in detail in FIG. 1, as a block diagram of workstation 115. In one embodiment, the internal operations of workstation 115 is directed and coordinated by controller 160.

When performer 111 is performing, e.g., singing, into microphone 112, the electric audio signal enters the workstation 115 at audio input 161. The audio input 161 digitizes the audio signals from microphone 112, to produce audio data. It should be mentioned that singing into microphone 112 is just an example performance and device. An actor could be using the microphone, for example in a dubbing session where dialog of a film is being re-recorded, or a musician might be playing an acoustic instrument, or instead of microphone 112, there may be a musician using an electric guitar with an electronic pickup or effects boxes feeding audio input 161.

Often, the digital audio data from audio input 161 is grouped into frames, each frame containing a predetermined number of samples of audio data, each digitized sample having been made by audio input 161 at a predetermined sample rate. Thus, the frame size imposed by audio in 161 might be described as the number of samples (e.g., 256) at the sample rate (e.g., 48 KHz), or as an interval (e.g., 5.33 mS) at the sample rate.

To best optimize the system, the frame size obtained from the audio in 161 is maintained throughout in subsequent modules. However, in some embodiments this is not possible, for example if microphone 112 were to provide digital audio data of its own. In such an alternative embodiment, audio input 161 accepts the digital audio, and may need to re-frame the audio data as needed to match the rest of the system. In another alternative embodiment, the rest of the system may be able to adapt to the intrinsic frame size output by microphone 112.

The internal structure of one embodiment of audio workstation 115 is also shown in FIG. 1, wherein, within the block representing audio workstation 115, thick lines represent video data paths, thin lines represent audio data paths, and dotted lines represent control paths.

Controller 160 causes the audio data produced by audio input 161 to be directed to two places: The audio data is recorded in store 162 as a track file, and may be recalled later for playback or full fidelity exchange. This is important, because the other place that the audio data is directed is audio watermarking module 163.

The behavior of audio watermarking module 163 is to alter the audio data in a way that, at least to human perception, alters the character of the audio program little. However, the altered audio data carries additional data, i.e., the watermark, which can be recovered from a copy of the audio data. Audio watermarks are well known, for example those originally offered as “CineFence” audio marking by Royal Philips Electronics of Amsterdam, Netherlands and now provided by Civolution, Inc., of Eindhoven, Netherlands.

In the present invention, controller 160 configures watermarking module 163 to use a different watermark for each remote workstation (workstations 125 & 135 are the remote workstations relative to workstation 115).

Controller 160 selects a distinct watermark for each of the remote workstations. The selection may be made once, it may be made for each project, session, track, or even for each take. The association between the originating station (e.g., 115), remote workstation (e.g., 125), and the particular project, session, track, and/or take, is stored by controller 160 in database 150. The other workstations 125, 135 note their watermark records in database 150, too. Note that with a policy of using a one-time selected watermark for a particular remote station, there is no need for dynamically updating a watermark record in database 150 since the relationship between the watermark and the remote station can be considered to be predetermined.

With a separate watermark applied to the audio data to be sent to each remote workstation, the audio may be encoded by a codec encode module 164a, then sent through communications interface 165, which creates the connection between workstation 115 and communication channel 140. The opposite occurs for encoded audio data received at the communications interface 165 from either remote workstation 125, 135, which is decoded by a codec decode module 164b. A good example of a codec for use in this application is the “CELT” ultra-low delay audio codec distributed as an open source project by Xiph.org Foundation of Somerville, Mass. (A description of the CELT codec, “A High-Quality Speech and Audio Codec With Less Than 10-ms Delay” by Valin, et. al, was published in “IEEE Transactions on Audio, Speech, and Language Processing”, volume 18, issue 1, pages 58-67 in January of 2010.)

To be best suited to the real time nature of the collaborative performance, the watermarking module 163 should work on the same size frame as provided from the audio input 161. Likewise, the codec should be able to operate using the same frame size. However, non-optimal though it may be, the frames to or from any of modules 161, 163, and 164a can be concatenated or split as needed to provide a different frame size as needed by a successor module, the penalty being that there is additional latency induced in the total transport of the performance to the remote workstations while waiting for additional frames to be captures or processed. This does not substantially affect the overall throughput of the system, just the amount of time it takes a typical audio sample to make it from the point of origin to being played out remotely.

Upon receiving encoded real time audio data from remote workstations 125, 135, codec decode module 164b performs a decode and directs to real time audio data (with embedded watermark) to both the store 162, for later playback, and to the synchronization module 167, for real time playback.

As used herein, by the term “audio data” is meant a digital representation of an audio performance, and whether that representation has been encoded or not, or watermarked or not, is usually explicitly indicated, or may be derived from the context of the portion of the system in which it appears. By the term “audio track” or in some instances just “track”, is meant audio data having or associated with an explicit relationship to the timing reference, e.g., by timecode. Thus, a set of digitized audio signals would be audio data, but when the relationship between the audio data and a timing reference is recorded too, the term “audio track” is used. The same convention is used herein with respect to video data and video tracks.

Per Redmann, the controller 160 communicates through interface 165 with each of the other workstations 125, 135, and characterizes the respective latencies through communications channel 140. This latency information may be used to configure delays (not shown) internal to the synchronization module. At the start of a take (an single instance of contiguous recording), controller 160 specifies a timecode. The timecode is communicated to the audio input 161, which can mark the audio data both in the stream and file. Selected previously recorded tracks may played back in synchrony with the recording being made, with the delays internal to the synchronization module 167 configured by controller 160 to have their timecodes substantially aligned before being output to the mixer 168 where they are combined and sent to the audio output 166 for presentation to the performer 111 through headphones 113 or speakers (not shown). In some operations, the timecode specified by controller 160 is actually derived from a timecode embedded in a track playing back from store 162. Track store 162 may also include video tracks, for example from a movie being produced, where controller 162 directed the video track to be output through synchronization module 167, where timecode may be extracted and provided to controller 160, the video data proceeding to video output 169 and on to display 114 to be viewed by performer 111. By this mechanism, the audio data produced by audio input 161 can obtain a timecode allowing the newly recorded track to be replayed in synchronization with the video track. Further, as the real time audio data, watermarked and encoded, is received by remote workstations 125, 135, the playout of the real time audio data there will be synchronized to a copy of the video track playing there too. Here, the playout of the remote video can be delayed by at least the latency anticipated in the transport of the audio across the communication channel 140.

In another mode of operation, as taught by Redmann, pre-recorded tracks in store 162 at both local and remote workstations 115, 125, 135 (which in the present invention may comprise video tracks), can all run simultaneously, and the performer 111 can be presented with his own current performance by allowing the real time audio data from audio input 161 to be delayed by the synchronization module 167 for an amount of time at least partially determined by the latency of communication channel 140, before passing through the mixer 168 and audio output 166 to be presented on headphones 113. The latter configuration induces the performer to “play ahead” or perform “on top of the beat” and is appropriate when multiple performers at different workstations are simultaneously producing audio tracks to be recorded as parts of the same take.

Pre-recorded audio and/or video reference tracks, such as a video track for a portion of a movie, even a partially completed portion as an animatic might represent, can be provided to the audio workstations in advance of or during a session. Since a pre-release video track of an upcoming movie may represent an extremely high-value asset, the track may be watermarked prior to distribution (which need not be a real time process) and may further be encrypted to limit access only to the audio workstations. If keys to the encrypted tracks are not supplied until the session begins (or shortly before hand), there is a reduced opportunity for the video reference track to be illicitly copied or otherwise obtained.

Not shown is a user interface suitable for managing a distributed multi-track recording session, as these are well known in the art, for example in the eJamming® Audiio product offered commercially by eJamming, Inc., of Valley Village, Calif. Through such an interface, each of the participating audio workstations 115, 125, and 135 are configured to join a common session. Once joined, a substantial portion of the technical operation can be undertaken by one of the operators at any of the locations 110, 120, and 130 to initiate recordings (“takes”), load and, as needed, distribute reference tracks, modify the mix, etc. Individually, the other operators can alter the mix to suit themselves, for instance if one performer needs to hear a bit more of the bass line during his performance, etc.

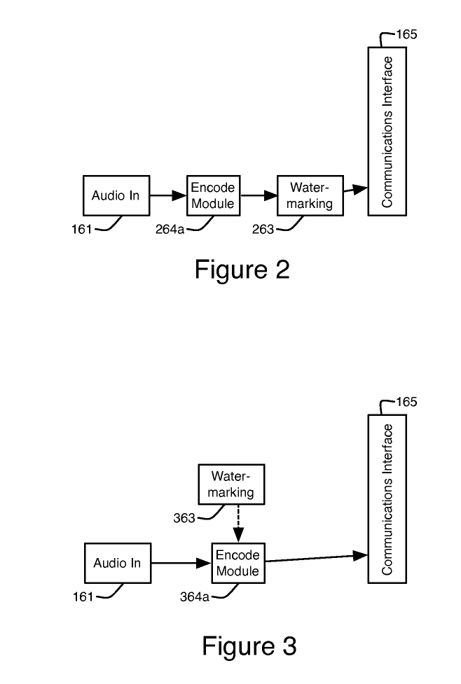

FIGS. 2 and 3 show alternative arrangements of watermarking module 163 and codec encode module 164a. In FIG. 1, watermarking module 163 acts to modify the audio data obtained from audio input 161 prior to action of encoder 164a. In this configuration, the applied watermark must survive the encoding process applied by encoder 164a and the subsequent decode processes at the remote workstations. Further, the watermark should survive deliberate attempts to eradicate it.

FIG. 2 shows a different configuration, wherein a codec encode module 264a, which might be identical to encoder 164a, acts directly on audio data obtained from audio input 161, before the watermark is applied, producing an encoded audio data stream. Watermarking module 263 must act on the encoded audio data. If codec encoder 264a is a simple bandwidth reduction, e.g., an appropriate low-pass filter to meet the Nyquist criteria and a commensurate downsampling of the audio data (in either or both of number of samples and bits per sample), then the resulting compressed stream is still substantially an audio signal, though of a lower resolution. As such, the watermarking module 263 may act on such a compressed audio data in much the same way as did module 163, with allowance made for the changes in sample rate and bit depth, etc. Were the watermarking module 263 to imprint its mark by adding a particular pseudorandom noise pattern or by imposing a patterned filtration, the same techniques could be applied to either the original audio data, or to the compressed audio data from encoder 264a.

However, if codec encoder 264a generated a coded stream, where some bits in the a frame of the stream determine what functions other bits of the frame control, then specific bit positions would not consistently have the same function (e.g., in a given code frame, say that bits 12-14 are a 3-bit representation on a scale 0-100% for the amplitude of a particular noise source used by the corresponding codec decoder in the reconstitution of the audio data. However, in the next code frame, those bits can be differently allocated. The changing allocation of individual bits in the code frame to different functions may vary according to a number of modes. For codecs where this is the case, the watermarking module 263 must be able to parse and manipulate the code stream provided by encoder module 263, in which case the watermarking module 263 is intimately tied to the codec selected.

The configuration of FIG. 2 is valuable if encoding is relatively expensive, since it need only be performed once, regardless of how many remote workstations are connected. If a watermarking technique similar to that used by watermark module 163 is applied to compressed audio data, one might expect watermarking module 263 to be computationally less expensive still, as the audio data has been reduced in bit depth and or number of samples. However, if the watermarking technique of module 263 consumes too much processing time analyzing the code stream in order to modify it, then any advantage of this configuration due to having only a single encode may be lost.

FIG. 3 shows another configuration where the watermarking module 363 is intimately related to the codec encode module 364a. In this configuration, the audio data obtained from audio input 161 is provided to the codec encode module 364a, which acts to encode the audio data. However, here the watermarking module 363 manipulates individual parameters in the encode module, thus affecting the resulting code stream that is distributed to the remote workstations.

For example, were encode module 364a to implement the CELT codec as described by Valin (op. cit.), then one of the techniques used by watermarking module 363 could be to differentially modify specific MDCT (Modified Discrete Cosine Transform) coefficients representing the spectrum of a critical band. The differential modification is desirable because the energy of the band should remain substantially unchanged. Coordinated modifications made to the spectra of different bands in each frame, further coordinated over many frames, would make a recoverable watermark.

From the foregoing, it should be apparent that, for some embodiments, there can be an intimate coupling between the watermarking process and the encode module of the codec, but that in other embodiments, general purpose watermarking modules and codecs may be used.

Still other embodiments (not shown) of the encoder/watermarking module combination are possible: For example, having a single, fixed watermarking process applied to the audio data obtained from audio in 161, but two encode modules. One encode module would encode the watermarked audio data, while the other would encode the unwatermarked audio data. Controller 160 would be tasked to select, on a frame-by-frame basis, using a unique pseudo-random pattern, whether the encoded frame from the watermarked audio data, or from the unwatermarked data should be sent to each remote workstation.

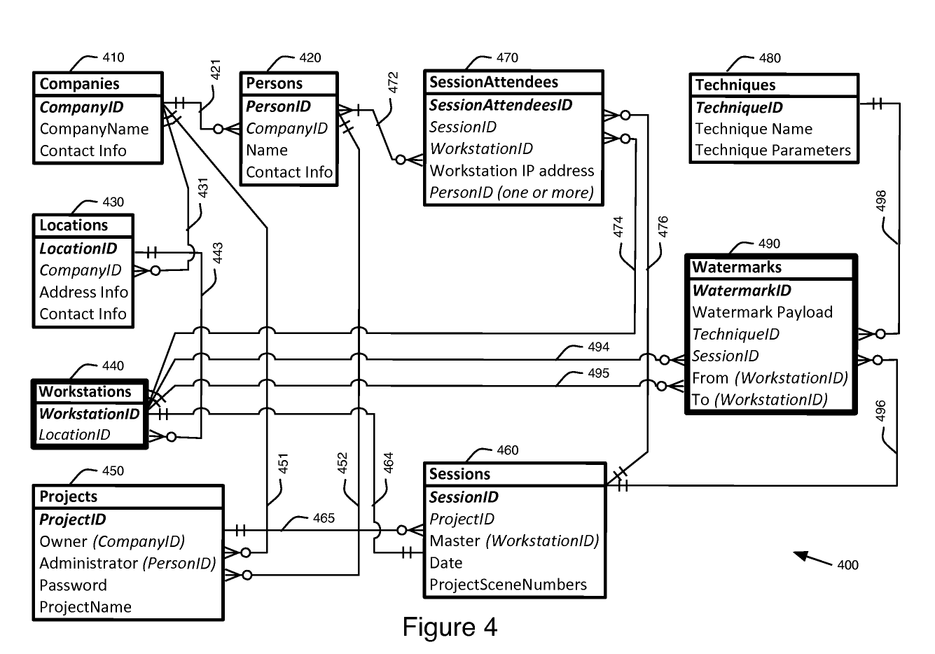

FIG. 4 shows one example database schema 400 suitable for implementing database 150. The primary function of database 150 is to track watermarks and their relationships to audio workstations, indicated by the bold outlines of watermarks table 490 and workstations table 440. The reason for this is that an audio workstation, though protected and cared for, is unlikely to be implemented as a secure device, so watermarks need to be tracked contemporaneously.

Were audio workstations implemented as cryptographically secure devices, then secure sessions and secure watermarking would be possible and the watermarks table 490 would be unnecessary: The only tracking required would be to know who was responsible for which workstations over which range of dates because the rest of the relationship recorded in watermarks table 490 could be embedded in the watermark payload. For example, if each workstation had a secure identification in the form of a public and private key (not shown), then the secure identification could be used to create an authenticated connection between two workstations. Controller 160 could then use the remote station's public key or a reliably conveyed serial number (using fewer bits) to indicate to which workstation a track is being sent, and (optionally) the current date to form a watermark payload to be carried in the real time encoded audio data sent to the remote audio workstation. If desired, a workstation can authenticate a watermark with a digital signature using its own private key. A forensic analysis made of the resulting real time audio would reveal the destination workstation and the date (if included), and because of the secure nature of the workstations and the digital signature, the watermark could be trusted.

However, as audio workstations are anticipated to not be cryptographically secure, watermark information is stored in database 150 contemporaneously.

In an alternative embodiment, other information can be used as a payload in the watermark. For example, a unique sequence number might be used, or the date and time. In one embodiment, an operator identification can be collected from each a remote workstation and used to watermark audio data sent to that station. The highest value of a forensic watermark is achieved when the watermark is unambiguously traceable to a specific machine or recipient (e.g., workstation, or workstation operator). However, a majority of embodiments may use general-purpose personal computers, which at this time are generally not cryptographically secure devices. For example, were time and date used as part of a watermark payload, while the PC's clock was in error, then forensic analysis of a watermark traced back to a workstation might be made more difficult. Alternatively, the time and date might be agreed upon by the workstations as the session commences, and may be similar to that of a reliable time server.

Example database structure 400 comprises companies table 410, persons table 420, locations table 430, workstations table 440, projects table 450, sessions table 460, session attendees table 470, techniques table 480, and watermarks table 490. Of this, watermarks table 490 is the most crucial; as it is populated with each watermark payload generated within system 100 and identifies which workstation generated the payload, and which workstation received it. The rest of the schema 400 provides a convenient mechanism to for tracking real-world information useful for the management of the system and helpful, but not required to be in database 150, for the forensic analysis of watermarks found in illicit copies of audio data.

Companies table 410 lists organizations (companies) that are typically the ultimate owners of audio data (content), i.e., the copyright holder. Also included are organizations, for example post-production houses, that may be hired by the content owners to perform a service requiring manipulation of the content, for example, dubbing or track clean up, etc.

Persons table 420 lists key employees or consultants, each associated with a single company by “affiliated” relationship 421. Individuals listed in persons table 420 will later be associated with working sessions, so it is convenient to track them.

Locations table 430 notes the various facilities where audio workstations will be located, each location associated with a company by “operated by” relationship 431. A location could be a recording studio, or studio lot, or it could be a musician's or director's home office.

Workstations table 440 tracks individual audio workstations, and associates each with a location in table 430 by “located in” relationship 443. If the audio workstations are cryptographically secure, their public keys and serial numbers may be noted here (not shown).

Projects table 450 is a main record for collecting work related to a project, which might be a movie, an album, or other larger unit of work. If the concept does not apply to a session, then this might correspond to a contract number or job number. Projects are associated with an owner, typically a company, by “owned by” relationship 451, and each project has an administrator identified by “administered by” relationship 452. The administrator has a password or other authentication mechanism (which would be stored as a hash or in encrypted form).

Sessions table 460 keeps track of the individual working sessions for a project identified by “working on” relationship 465 (which might also be called “bill to”, since it can be used to identify a session as work for a particular client company). In each session, one workstation is identified as the master through “hosting station” relationship 464. Though other organizational policies may be selected, one can be that the workstation that sets up and initiates the session is the workstation that, at the end of the session, receives all the masters: the unwatermarked tracks, from each of the other audio workstations in the session.

Session attendees table 470 is a linking table associating each workstation with each session it joins, through “attended through” relationship 474 (which identifies a workstation) and “attended session” relationship 476 (which identifies the session the workstation joined). Additionally, as a check, the IP address of the workstation can be noted. While this is necessary data for operating the session so that workstations in a session can connect with other workstations in the session, the primary reason for it existing in database 150 is a forensic one: It can provide information of value when analyzing a illicit release of the content. In the embodiment shown, at least the audio workstation operator (who may be a performer or other artist) is noted with “present” relationship 472, which (in this embodiment) requires one and allows more persons to be associated with the workstation for this session. Thus, were audio workstation 115 capturing a performance from singer 111 and in addition, singer 111 was assisted by a coach and recording engineer (either shown) both at location 110, then the corresponding session attendees record in table 470 for that session and workstation could have the “present” relationship 472 with records in the persons table 420 corresponding to each of the singer 111, coach, and engineer as a way to log the individuals present at location 110.

In an alternative embodiment, the many-to-many “present” relationship 472 needed between records in the session attendees and persons tables 470 and 420, may be implemented with a separate linking table

If more than one watermarking technique is employed in system 100, then the various types of watermark may be noted in techniques table 480. Watermarks table 490 contains a record of the watermark payload used in each session to send an audio track from one workstation to another workstation. Either the payload alone, or the payload with the watermarking technique, as indicated by “how watermarked” relationship 498, should allow a single record to be identified within watermarks table 490 which will identify the source and destination audio workstations for the audio track so watermarked. “Used in session” relationship 496 identifies the session in which the watermark was used, and “watermarked by” relationship 494 and “watermarked for” relationship 495 each point to a respective audio workstation.

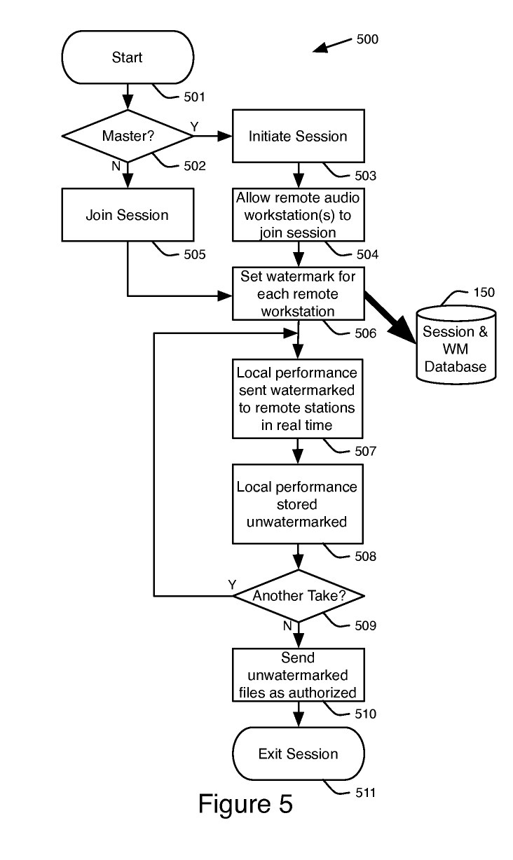

FIG. 5 shows a flowchart for a secured collaboration process 500 that uses the audio workstations and system 100 of FIG. 1. At start 501, an audio workstation, e.g., 115, is ready for operation.

If, at 502, the audio workstation is to be the master, then at 503 a session is initiated and at 504 one or more remote workstations are allowed to connect and join the session.

However, if at 502 the audio workstation is not to be the master of the session, then at 505 it joins the session created by the remote audio workstation that is the master.

If communication channel 140 spans only a small network, then a session can be advertised by the master or sought by a non-master with a broadcast message. However, if communication channel 140 spans a larger network not supporting such global broadcasts, the a lobby server (not shown, but well known) may be provided with a widely known domain name or network address so that it is easily found by audio workstations. Sessions can be created or found and joined through the lobby server.

As a remote audio workstation joins a master audio workstation's session, it learns of all the other participating workstations, as conversely they learn of the newly joined participant workstation.

The process of initiating or joining the session may create a record such as those in session attendees table 470.

In one embodiment, at 506, the audio workstation deposits in database 150 a record of the watermark it will be using for each remote workstation for this session, for example as described above with respect to watermarks table 490.

For each take, at 507, the local performance captured through audio input 161 is watermarked and sent to the remote stations in real time. At 508, the local performance is recorded in store 162 unwatermarked. Subsequently, if another take is desired at 509, the process loops back to step 507 for another local performance.

When no further takes are needed in the current session, the unwatermarked tracks recorded at 508 in store 162 may be transferred at 510 according to policy. For example, the unwatermarked tracks might be sent to the master audio workstation. Under a different policy, an authorized session participant (e.g., using the administrator password for the project in table 450 with which the session is associated) may cause the unwatermarked tracks to be transferred to the audio workstation at which he is present (e.g., as recorded in “present” relationship 472). Other policies may be implemented in addition to, or in lieu of these, as a business operations choice.

At 511, the session is complete and the workstation disconnects from the other workstations. Depending on the policies of those entities managing system 100, all tracks, watermarked or otherwise may be erased immediately, or in short order, with the exception of the master audio workstation, or whichever workstation was designated to receive the unwatermarked tracks. Likewise, when they are no longer required, tracks used for timing reference may be erased, too. Such policies are intended to minimize the chance that lingering audio or video tracks are extracted and improperly distributed. The management responsible for a particular audio workstation will generally be inclined to ensure the selected policies are followed, so as not to have their facility implicated by a watermark in illicitly leaked data.

The invention as herein described ensures that audio data, created and distributed in real time, is watermarked, thereby ensuring that responsibility for illicitly releasing a copy of the data is traceable to the specific workstation and by association, the organization responsible for the release.

Various additional modifications of the described embodiments of the invention specifically illustrated and described herein will be apparent to those skilled in the art, particularly in light of the teachings of this invention. It is intended that the invention cover all modifications and embodiments that fall within the spirit and scope of the invention. Thus, while preferred embodiments of the present invention have been disclosed, it will be appreciated that it is not limited thereto but may be otherwise embodied within the scope of the following claims.

I claim:

1. A first audio workstation comprising:
an audio input;
a watermarking module;
a store;
an interface to a communication channel; and,
a controller, wherein
said controller captures an audio performance through said audio input as first audio data,
said controller records the first audio data as a first audio track in the store,
said controller applies a first watermark to the first audio data with said watermark module to produce a second audio track, and,
said controller sends said second audio track through the interface to a remote second audio workstation connected to said communication channel in substantially real time.

2. The first audio workstation of claim 1, wherein
a first record stored in a database associates said first watermark with the remote second audio workstation.

3. The first audio workstation of claim 2, wherein
said database is a remote database having communication with said first audio workstation through said communication channel.

4. The first audio workstation of claim 2, wherein
said controller applies a second watermark to the first audio data with said watermark module to produce a third audio track,
said controller sends said third audio track through the interface to a remote third audio workstation connected to said communication channel in substantially real time, and,
a second record stored in the database associates said second watermark with the remote third audio workstation.

6. The audio workstation of claim 4, wherein
said database is a remote database having communication with said first audio workstation through said communication channel.

7. The first audio workstation of claim 1, wherein
said audio performance is by a performer;
said controller presents a timing reference to the performer while the first audio data is recorded;
said controller determines a synchronization between the first audio data and the timing reference;
said first audio track further comprising data representative of the synchronization.

8. The first audio workstation of claim 7, wherein
said data representative of the synchronization is a timecode.

9. The first audio workstation of claim 7, further comprising:
an audio output; wherein
said timing reference comprises a metronome played through said audio output.

10. The first audio workstation of claim 7, further comprising:
an audio output; wherein
said timing reference comprises a countdown played through said audio output.

11. The first audio workstation of claim 7, further comprising
an audio output; wherein,
said store contains a reference track, comprising a second audio data;
said timing reference is the reference track played through said audio output.

12. The first audio workstation of claim 7, further comprising
a video output; wherein,
said store contains a reference track, comprising video data;
Re

13. The first audio workstation of claim 1 wherein:
said controller sends a copy of the first track to the first audio workstations through the interface.

14. The first audio workstation of claim 1 wherein:
the copy of the first track is encrypted.

15. The first audio workstation of claim 1, further comprising
an audio output; wherein
said controller receives a third audio track through the interface from the second audio workstation in substantially real time,
said controller plays the third audio track though said audio output while the first audio track is recorded,
said controller determines a synchronization between the first and third audio tracks;
said first audio track further comprising data representative of the synchronization.

16. The first audio workstation of claim 15, wherein
the synchronization is at least partially determined from the latency of the communication channel between the first and second audio workstations.

17. A method for distributed collaboration comprising:
providing a first audio workstation comprising an audio input, a watermarking module, a store, and having a connection to at least one second audio workstation through a communication channel;
logging with the workstation an association between each of the second audio workstations and a different watermark payload;
capturing first data representative of a performance through said audio input;
producing a second data for each of the second audio workstations by watermarking the first data with the watermarking module and the corresponding watermark payload;
sending the corresponding second data to each of the second audio workstations through the communication channel in substantially real time; and,
recording a track comprising the first data in the store.

18. The method of claim 17, further comprising:
sending the track to one of the second audio workstations.

19. The method of claim 17, wherein the first audio workstation further comprises an output and said store contains a reference track, the method further comprising:
playing the reference track through the output;
wherein said track further comprises third data representative of the synchronization between the reference track and the performance.

20. The method of claim 19, wherein the reference track comprises at least one of video and audio.
